(19) United States
(12) Patent Application Publication
(10) Pub. No.: US 2021/0233027 A1
(43) Pub. Date: Jul. 29, 2021

(54) METHOD FOR CONDUCTING STATISTICS ON INSURANCE TYPE STATE INFORMATION OF POLICY, TERMINAL DEVICE AND STORAGE MEDIUM

(71) Applicant: PING AN TECHNOLOGY (SHENZHEN) CO., LTD., Shenzhen, Guangdong (CN)

(72) Inventor: Haiping WANG, Shenzhen (CN)

(21) Appl. No.: 16/301,429

(22) PCT Filed: Feb. 12, 2018
(86) PCT No.: PCT/CN2018/076520

§ 371 Date: Nov. 13, 2018

(30) Foreign Application Priority Data
Aug. 8, 2017 (CN) 201710669475.3

(51) Int. Cl. G06Q 10/10; G06Q 30/00; G06F 16/22; G06F 16/23; G06F 16/245; G06F 7/08

(52) U.S. Cl. CPC G06Q 10/10; G06Q 30/018; G06F 7/08; G06F 16/2358; G06F 16/245; G06F 16/2282

(57) ABSTRACT

The present application is applicable to the technical field of insurance type information processing, and provides a method for conducting statistics on insurance type state information of a policy, a terminal device, and a storage medium. The method includes receiving a unique identifier of an insurance type of a policy; searching for, in a log table, all state change records corresponding to the unique identifier of the insurance type of the policy; sorting all the found state change records in chronological order; determining whether two adjacent state change records are the same; when the two adjacent state change records are different, subtracting the time point of the previous state from the time point of the latter state change record to obtain a time interval; and determining the duration of a valid state based on the time interval. Through the above method, the data processing efficiency can be greatly improved.

The present application claims priority to Chinese Patent Application No. 201710669475.3, entitled “METHOD FOR CONDUCTING STATISTICS ON INSURANCE TYPE STATE INFORMATION OF POLICY, TERMINAL DEVICE AND STORAGE MEDIUM”, filed to China Patent Office on Aug. 8, 2017, the contents of which are all incorporated herein by reference in their entireties.

### TECHNICAL FIELD

The present application belongs to the technical field of insurance type information processing, and in particular relates to a method for conducting statistics on insurance type state information of a policy, a terminal device, and a storage medium.

### BACKGROUND

The insurance type of a policy has a variety of states, which can be roughly divided into a valid state and an invalid state. Companies usually only focus on the insurance type of policies being in a valid state.

In the course of subscription and renewal for the insurance type of a policy, its state may be continuously valid, or there may be repeated occurrences where its state changes from valid to invalid, and back to valid, or the insurance type has been invalid since a certain point in time. Data of these changes is recorded in a log table, and one record is generated for each change. As the policies are being continuously increased, the data volume of the log table will also continuously increase, and the data volume at a hundred million level will appear.

In an existing statistics method for valid state of the insurance type of policies, at first, a policy number is determined, state change records corresponding to the policy number are searched for in the log table according to the policy number, the time interval between every two adjacent change records among all change records of the policy number is counted, and then time intervals corresponding to the invalid state in the time intervals are filtered out, so as to obtain time intervals corresponding to the valid state, and the time intervals corresponding to the valid state is accumulated to obtain the duration of the valid state of the policy number. All policy numbers are traversed circularly until the duration of the valid state corresponding to all policy numbers is counted.

Because the time interval between every two adjacent change records needs to be counted, it may lead to too long statistical time for the valid state duration of each policy number.

### SUMMARY

Because the time interval between every two adjacent change records needs to be counted, it may lead to too long statistical time for the valid state duration of each policy number.

In view of this, an embodiment of the present application provides a method for conducting statistics on insurance type state information of a policy, a terminal device, and a storage medium, so as to solve the problem in prior art that, since it is necessary to count the time interval between every two adjacent change records, it may lead to too long statistical time for the valid state duration of each policy number.

A first aspect of an embodiment of the present application provides a method for conducting statistics on insurance type state information of a policy, which includes:

receiving a unique identifier of an insurance type of a policy;

searching for, in a log table, all state change records corresponding to the unique identifier of the insurance type of the policy;

sorting all the found state change records in chronological order;

determining whether two adjacent state change records are the same;

when the two adjacent state change records are different, subtracting the time point of the previous state from the time point of the latter state change record to obtain a time interval; and

determining the duration of a valid state based on the time interval.

A second aspect of an embodiment of the present application provides a terminal device, which includes a memory, a processor, and a computer readable instruction stored in the memory and executable on the processor, where the processor implements the following steps when executing the computer readable instruction:

receiving a unique identifier of an insurance type of a policy;

searching for, in a log table, all state change records corresponding to the unique identifier of the insurance type of the policy;

sorting all the found state change records in chronological order;

determining whether two adjacent state change records are the same;

when the two adjacent state change records are different, subtracting the time point of the previous state from the time point of the latter state change record to obtain a time interval; and

determining the duration of a valid state based on the time interval.

A third aspect of an embodiment of the present application provides a computer readable storage medium, having stored thereon a computer readable instruction, where when the computer readable instruction is executed by the processor, the steps of the method for conducting statistics on insurance type state information of a policy according to any one are implemented.

A fourth aspect of an embodiment of the present application provides a device for conducting statistics on insurance type state information of a policy, which includes an identifier receiving unit, configured to receive a unique identifier of an insurance type of a policy;

a record searching unit, configured to search for, in a log table, all state change records corresponding to the unique identifier of the insurance type of the policy;

a record sorting unit, configured to sort all the found state change records in chronological order;

a record judgment unit, configured to determine whether two adjacent state change records are the same;

a record processing unit is also configured to subtract the time point of the previous state from the time point of the latter state change record when the two adjacent state change records are different, to obtain a time interval; and

a duration determining unit, configured to determine the duration of a valid state based on the time interval.

Compared with the prior art, an embodiment of the present application has the beneficial effects:

because the time interval between two adjacent state change records is calculated only when the two adjacent state change records are different, the calculation efficiency can be greatly improved when the duration of a valid state is determined according to the time interval.

### BRIEF DESCRIPTION OF DRAWINGS

In order to illustrate the technical solutions in the embodiments of the present application more clearly, the accompanying drawings used in description of the embodiments or the prior art will be briefly described below. Apparently, the accompanying drawings in the following description are only some embodiments of the present application. For those of ordinary skills in the art, other accompanying drawings may also be obtained without creative labor.

FIG. 1 is a flowchart of a method for conducting statistics on insurance type state information of a policy according to an embodiment of the present application;

FIG. 2 is a structural schematic diagram of a device for conducting statistics on insurance type state information of a policy according to an embodiment of the present application; and

FIG. 3 is a schematic diagram of a terminal device according to an embodiment of the present application.

### DETAILED DESCRIPTION OF EMBODIMENTS

In the following description, for the objective of description rather than limitation, specific details such as specific system architectures and technologies are set forth, in order to thoroughly understand the embodiments of the present application. However, it will be apparent to those skilled in the art that the present application may also be implemented in other embodiments without these specific details. In other instances, detailed descriptions of well-known systems, devices, circuits, and methods are omitted, lest unnecessary details hinder the description of the present application.

In order to explain the technical solutions of the present application, the following description will be made by way of specific embodiments.

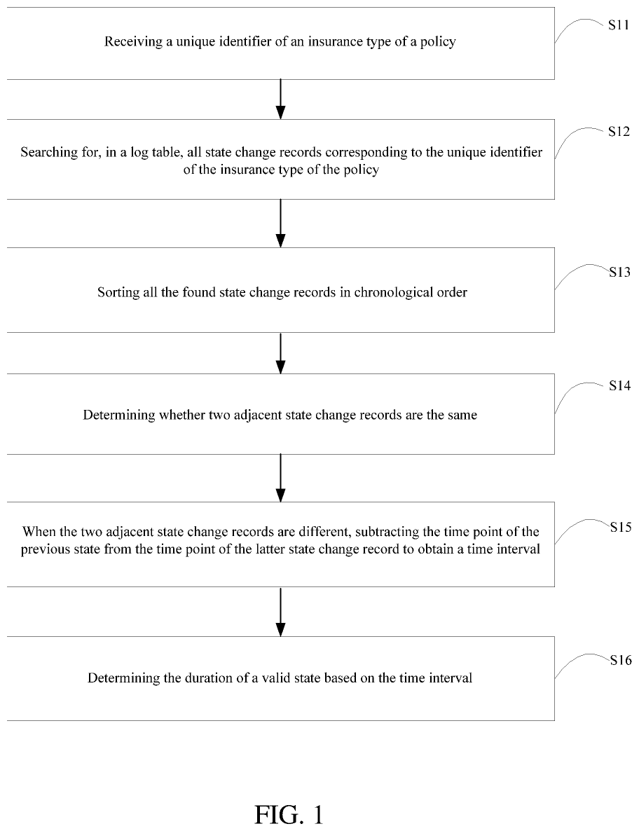

FIG. 1 illustrates a flowchart of a method for conducting statistics on insurance type state information of a policy according to Embodiment 1 of the present application, which is described in detail as follows:

Step S11: receiving a unique identifier of an insurance type of a policy.

In this case, the unique identifier of the insurance type of the policy is usually a policy number. When a user needs to conduct statistics on the duration of a valid state of the insurance type of a certain policy, the unique identifier of the insurance type of the policy needs to be input or imported. Optionally, when there are multiple unique identifiers of insurance types of policies (for example, 50,000), batch processing interfaces are opened to receive the unique identifiers of the insurance types of the multiple policies in parallel, thereby improving the statistical speed of insurance type state information of subsequent policies.

Step S12: searching for, in a log table, all state change records corresponding to the unique identifier of the insurance type of the policy.

Because state change records of the insurance type of each policy is recorded in the log table, in order to facilitate quick counting of the duration of the valid state of the insurance type of a certain policy, firstly, all state change records of the insurance type of the policy are found in the log table. Of course, this is also convenient for users to view and reduces the search time. It should be noted that if insurance type state change records of a policy are stored in a plurality of log tables, it is necessary to search for the insurance type state change records from the plurality of log tables.

Optionally, when a state change record of a policy spans a long period of time, if only state change records of insurance type for a certain period of time needs to be counted, step S12 specifically includes:

Step A1: receiving start time and end time of the user input to determine the time range of a log table to be searched for.

Step A2: searching for, in a time range of the log table, all state change records corresponding to the unique identifier of the insurance type of the policy.

In the above steps A1-A2, based on the time range of the log table to be searched for, all the state change records corresponding to the unique identifier of the insurance type of the policy are searched for in one or more log tables.

Step S13: sorting all the found state change records in chronological order.

Specifically, when there are a plurality of state change records, the plurality of state change records are usually separately recorded in one or more log tables, so after all state change records of an insurance type of a policy are found, it is necessary to arrange the found state change records in chronological order, such as sorting the earlier recorded state change records in front of the later recorded state change records, so as to subsequently obtain the exact duration of the valid state.

Step S14: determining whether two adjacent state change records are the same.

Optionally, step S14 specifically includes:

Step B1: when the previous state change record is the valid state, and the latter state change record is the valid state, or when the previous state change record is the invalid state, and the latter state change record is the invalid state, determining that the two adjacent change records are the same. Specifically, as the insurance type of the policy has a variety of states, the states are usually marked with the following letters: I, P, A, W, R, J, B; and C, D, E, L, M, N, S, T, V, X, F, Z, Y, 0, 1, H, K, G, O, U. When it is determined that the letters of the states are marked as I, P, A, W, R, J, B, the state of the insurance type of the policy is marked as being a valid state; and when the letters of the states are marked as C, D, E, L, M, N, S, T, V, X, F, Z, Y, 0, 1, H, K, G, O, U, the state of the insurance type of the policy is marked as an invalid state.

Step B2: when the previous state change record is the valid state, and the latter state change record is the invalid state, or when the previous state change record is the invalid state, and the latter state change record is the valid state, determining that the two adjacent change records are different.

Step S15: when the two adjacent state change records are different, subtracting the time point of the previous state from the time point of the latter state change record to obtain a time interval.

Optionally, step S15 specifically includes:

when the two adjacent state change records are different and the valid state is changed to the invalid state, subtracting the time point of the previous state from the time point of the latter state change record to obtain a time interval.

It should be noted that when the two adjacent state change records are the same, no operation is performed.

Step S16: determining the duration of a valid state based on the time interval.

Optionally, step S16 includes:

Step C1: determining the end date and start date of the valid state.

Step C2: counting time intervals corresponding to the change of all state change records from the valid state to the invalid state, and accumulating all the counted time intervals to obtain the invalid duration of the policy.

Step C3: calculating the duration of the valid state of the policy based on the following formula:

(end date−start date)−invalid duration of the policy=the duration of the valid state of the policy.

Specifically, the state change records can be classified into three types, the first type is data that changes from the valid state to the invalid state, the second type is data that changes from the invalid state to the valid state, and the third type is data that changes from the valid state to the more valid state and data that changes from the invalid state to the more invalid state. By analyzing the data, it is concluded that the amount of data of the first type is the smallest, accounting for only about 20% of the total data, and the amount of data of the third type is the largest, accounting for about 60%; because data of the third type changes of the same state, this type of data can be ignored and does not affect calculation results.

In this case, the invalid duration of the policy in the above formula is the duration corresponding to the data of the first type, that is, only the data of the first type is required to participate in the calculation to obtain the duration of the valid state, thereby making the amount of data (such as the amount of log data) involved in the calculation decrease greatly.

Optionally, for the calculation of the duration of data of the first type, the method of sorting by policy, insurance type grouping, and log change date is used to calculate the time interval between two adjacent logs in batches by using an analysis function (such as using lag( )over, row_number( )over analysis function), and all the time intervals are accumulated to obtain the corresponding invalid duration, thereby improving the computation efficiency.

In an embodiment of the present application, a unique identifier of an insurance type of a policy is received; all state change records corresponding to the unique identifier of the insurance type of the policy are searched for in a log table; all the found state change records are sorted in chronological order; whether two adjacent state change records are the same is determined; when the two adjacent state change records are different, the time point of the previous state is subtracted from the time point of the latter state change record to obtain a time interval; and the duration of a valid state is determined based on the time interval. Since the time interval between two adjacent state change records is calculated only when the two adjacent state change records are different, the calculation efficiency can be greatly improved when the duration of a valid state is determined according to the time interval. That is, by identifying the pattern distribution of the data, invalid data are eliminated as much as possible without affecting the calculation result, thereby reducing the calculation amount. In addition, if the batch calculation method is adopted, the better calculation efficiency can be further achieved. By the processing in the above two points, the calculation speed is increased by about 10 times.

It should be understood that the size of the serial numbers of the steps in the above embodiments does not mean the order of execution. The order of execution of each process should be determined by its function and internal logic, and should not be construed as limiting the implementation process of the embodiments of the present application.

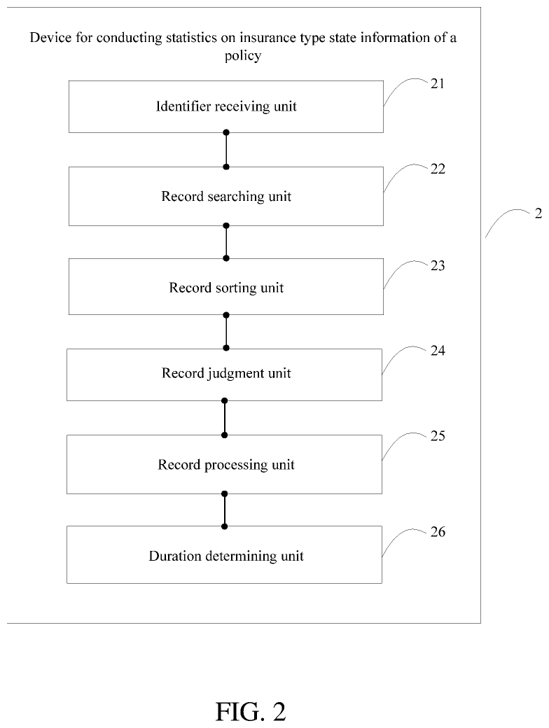

FIG. 2 illustrates a schematic structural diagram of a device for conducting statistics on insurance type state information of a policy according to an embodiment of the present application and the device includes an identifier receiving unit 21, a record searching unit 22, a record sorting unit 23, a record judgment unit 24, a record processing unit 25, and a duration determining unit 26.

the identifier receiving unit 21 is configured to receive a unique identifier of an insurance type of a policy;

a record searching unit 22 is configured to search for, in a log table, all state change records corresponding to the unique identifier of the insurance type of the policy;

a record sorting unit 23 is configured to sort all the found state change records in chronological order;

a record judgment unit 24 is configured to determine whether two adjacent state change records are the same;

a record processing unit 25 is further configured to subtract the time point of the previous state from the time point of the latter state change record when the two adjacent state change records are different, to obtain a time interval; and

a duration determining unit 26 is also configured to determine the duration of a valid state based on the time interval.

In the embodiment of the present application, the record processing unit 25 does not perform operation when the two adjacent state change records are the same.

Optionally, the record judgment unit 24 includes:

a first determining module, configured to determine that the two adjacent change records are the same, when the previous state change record is the valid state, and the latter state change record is the valid state, or when the previous state change record is the invalid state, and the latter state change record is the invalid state; and

a second determining module, configured to determine that the two adjacent change records are different, when the previous state change record is the valid state and the latter state change record is the invalid state, or when the previous state change record is the invalid state and the latter state change record is the valid state.

In the embodiment of the present application, the record processing unit 25 is specifically configured to subtract the time point of the previous state from the time point of the latter state change record when the two adjacent state change records are different and the valid state is changed to the invalid state, to obtain a time interval.

Optionally, the duration determining unit 26 includes:

a date determination module, configured to determine the end date and start date of the valid state;

an interval statistics module, configured to count time intervals corresponding to the change of all state change records from the valid state to the invalid state, and accumulate all the counted time intervals to obtain the invalid duration of the policy; and

a duration calculation module, configured to calculate the duration of the valid state of the policy based on the following formula:

(end date−start date)−invalid duration of the policy=the duration of the valid state of the policy.

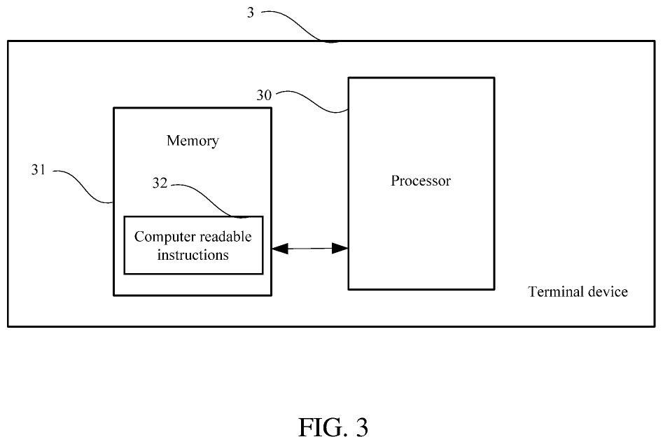

Corresponding to the method for conducting statistics on insurance type state information of a policy of Embodiment 1, FIG. 3 is a schematic diagram of a terminal device according to Embodiment 2 of the present application. As shown in FIG. 3, the electronic device 3 of this embodiment includes a processor 30, a memory 31 and a computer readable instruction 32 stored in the memory 31 and executable on the processor 30. When executing the computer readable instruction 32, the processor 30 implements the steps in the aforementioned embodiment of the method for conducting statistics on insurance type state information of a policy:

receiving a unique identifier of an insurance type of a policy;

searching for, in a log table, all state change records corresponding to the unique identifier of the insurance type of the policy;

sorting all the found state change records in chronological order;

determining whether two adjacent state change records are the same;

when the two adjacent state change records are different, subtracting the time point of the previous state from the time point of the latter state change record to obtain a time interval; and

determining the duration of a valid state based on the time interval.

Optionally, when the processor executes the computer readable instruction, the following step is also implemented:

when the two adjacent state change records are the same, performing no operation.

Optionally, the step of determining whether two adjacent state change records are the same includes:

when the previous state change record is the valid state, and the latter state change record is the valid state, or when the previous state change record is the invalid state and the latter state change record is the invalid state, determining that the two adjacent change records are the same;

when the previous state change record is the valid state, and the latter state change record is the invalid state, or when the previous state change record is the invalid state, and the latter state change record is the valid state, determining that the two adjacent change records are different.

Optionally, the step of subtracting the time point of the previous state from the time point of the latter state change record when the two adjacent state change records are different, to obtain a time interval includes:

when the two adjacent state change records are different and the valid state is changed to the invalid state, subtracting the time point of the previous state from the time point of the latter state change record to obtain a time interval.

Optionally, the step of determining the duration of a valid state based on the time interval includes:

determining the end date and start date of the valid state;

counting time intervals corresponding to the change of all state change records from the valid state to the invalid state, and accumulating all the counted time intervals to obtain the invalid duration of the policy;

calculating the duration of the valid state of the policy based on the following formula:

(end date−start date)−invalid duration of the policy=the duration of the valid state of the policy.

The terminal device 3 may be a computing device such as a desk calculator, a notebook, a palmtop computer, and a cloud server. The terminal device may include, but is not limited to, the processor 30, and the memory 31. It will be understood by those skilled in the art that FIG. 3 is merely an example of the terminal device 3 and does not constitute a limitation on the terminal device 3, and may include more or fewer components than those illustrated, or combine some components, or different components. For example, the terminal device may further include an input/output device, a network access device, a bus, and the like.

The processor 30 may be a central processing unit (CPU), or may be other general-purpose processors, a digital signal processor (DSP), an application specific integrated circuit (ASIC), a field-programmable gate array (FPGA) or other programmable logic devices, discrete gates or transistor logic devices, discrete hardware components, etc. The general purpose processor may be a microprocessor or the processor or any conventional processor or the like.

The memory 31 may be an internal storage unit of the terminal device 3, such as a hard disk or a memory of the terminal device 3. The memory 31 may also be an external storage device of the terminal device 3, such as, a plug-in hard disk disposed on the terminal device 3, a smart memory card (SMC), a secure digital (SD) card, and a flash card. Further, the memory 31 may also include both an internal storage unit of the terminal device 3 and an external storage device. The memory 31 is configured to store the computer readable instruction and other programs and data required by the terminal device. The memory 31 may also be configured to temporarily store data that has been output or is about to be output.

Those skilled in the art can clearly understand that for convenience and brevity of description, only the division of each functional unit and module described above is exemplified. In practical applications, the allocation of the above functions may be completed by different functional units and modules according to needs. That is, the internal structure of the device is divided into different functional units or modules to perform all or part of the functions described above. Each functional unit and module in embodiments may be integrated into one processing unit, or each unit may exist physically separately, or two or more units may be integrated into one unit. The above integrated unit can be implemented in the form of hardware or in the form of a software functional unit. In addition, the specific names of the respective functional units and modules are only for the purpose of facilitating mutual differentiation, and are not intended to limit the scope of protection of the present application. For the specific working process of the units and the modules in the foregoing system, a reference may be made to the corresponding process in the foregoing method embodiment, and details are not described herein again.

In the above embodiments, the descriptions of the various embodiments are different, and for the parts that are not detailed or described in a certain embodiment, see the related descriptions of other embodiments.

Those of ordinary skills in the art may be aware that the units and algorithm steps of the various examples described in combination with the embodiments disclosed herein can be implemented in electronic hardware or a combination of computer software and electronic hardware. Whether these functions are performed in hardware or software depends on the specific application and design constraints of the technical solution. A person skilled in the art can use different methods to implement the described functions for each particular application, but such implementation should not be considered to be beyond the scope of the present application.

In the embodiments according to the present application, it should be understood that the disclosed apparatus/terminal device and method may be implemented in other manners. For example, the device/terminal device embodiment described above is merely illustrative. For example, the division of the module or unit is only a logical function division, and the actual implementation may have another division manner. For example, multiple units or components may be combined or integrated into another system, or some features may be omitted or not implemented. In addition, the mutual coupling or direct coupling or communication connection shown or discussed may be an indirect coupling or communication connection through some interfaces, devices or units, and may be electrical, mechanical or otherwise.

The units described as separate components may or may not be physically separated, and the components displayed as units may or may not be physical units, that is, the units and the components may be located in one place, or may be distributed to multiple network units. Some or all of the units may be selected according to actual needs to achieve the objective of the solution of the embodiment.

In addition, each functional unit in each embodiment of the present application may be integrated into one processing unit, or each unit may exist physically separately, or two or more units may be integrated into one unit. The above integrated unit can be implemented in the form of hardware or in the form of a software functional unit.

The integrated module/unit, if implemented in the form of a software functional unit and sold or used as an independent product, may be stored in a computer readable storage medium. Based on such understanding, the present application implements all or part of the processes in the method of the foregoing embodiment, and may also be implemented by commanding related hardware through the computer readable instruction, which may be stored in a computer readable storage medium. The computer readable instruction, when executed by a processor, may implement the steps of the various method embodiments described above. The computer readable storage medium may include any entity or device capable of carrying the computer readable instruction code, a recording medium, a USB flash disk, a mobile hard disk, a magnetic disk, an optical disk, a computer memory, a read-only memory (ROM), random access memory (RAM), electrical carrier signals, telecommunications signals, software distribution media, etc. It should be noted that the content contained in the computer readable storage medium may be appropriately increased or decreased according to the requirements of legislation and patent practice in a jurisdiction. For example, in some jurisdictions, according to legislation and patent practice, the computer readable storage medium does not include electrical carrier signals and telecommunication signals.

The above embodiments are only used to illustrate the technical solutions of the present application, and are not intended to limit the technical solutions; although the present application has been described in detail with reference to the foregoing embodiments, those of ordinary skills in the art should understand that they can still modify the technical solutions recorded in each aforementioned embodiment, or perform equivalent substitutions on some of the technical features therein; and such modifications or substitutions do not make the essence of the corresponding technical solution depart from the spirit and scope of the technical solution of each embodiment of the present application, and should be included in the scope of protection of the present application.

1. A method for conducting statistics on insurance policy status information, comprising:
receiving a unique identifier of an insurance type of a policy;
searching for, in a log table, all state change records corresponding to the unique identifier of the insurance type of the policy;
sorting all the found state change records in chronological order;
determining whether two adjacent state change records are the same;
when the two adjacent state change records are different, subtracting the time point of the previous state from the time point of the latter state change record to obtain a time interval; and
determining the duration of a valid state based on the time interval.

2. The method for conducting statistics on insurance policy status information according to claim 1, wherein when the two adjacent state change records are the same, no operation is performed.

3. The method for conducting statistics on insurance policy status information according to claim 1, wherein the step of determining whether two adjacent state change records are the same comprises:
when the previous state change record is the valid state, and the latter state change record is the valid state, or when the previous state change record is the invalid state, and the latter state change record is the invalid state, determining that the two adjacent change records are the same;
when the previous state change record is the valid state, and the latter state change record is the invalid state, or when the previous state change record is the invalid state, and the latter state change record is the valid state, determining that the two adjacent change records are different.

4. The method for conducting statistics on insurance policy status information according to claim 3, wherein the step of subtracting the time point of the previous state from the time point of the latter state change record when the two adjacent state change records are different, to obtain a time interval comprises:
when the two adjacent state change records are different and the valid state is changed to the invalid state, subtracting the time point of the previous state from the time point of the latter state change record to obtain a time interval.

5. The method for conducting statistics on insurance policy status information according to claim 4, wherein the step of determining the duration of a valid state based on the time interval comprises:
determining the end date and start date of the valid state;
counting time intervals corresponding to the change of all state change records from the valid state to the invalid state, and accumulating all the counted time intervals to obtain the invalid duration of the policy;
calculating the duration of the valid state of the policy based on the following formula:
(end date−start date)−invalid duration of the policy=the duration of the valid state of the policy.

6. A terminal device, comprising: a memory, a processor, and a computer readable instruction stored in the memory and executable on the processor, wherein the processor implements the following steps when executing the computer readable instruction:
receiving a unique identifier of an insurance type of a policy;
searching for, in a log table, all state change records corresponding to the unique identifier of the insurance type of the policy;
sorting all the found state change records in chronological order;
determining whether two adjacent state change records are the same;
when the two adjacent state change records are different, subtracting the time point of the previous state from the time point of the latter state change record to obtain a time interval; and
determining the duration of a valid state based on the time interval.

7. The terminal device according to claim 6, wherein the processor also implements the following step when executing the computer readable instruction:
when the two adjacent state change records are the same, performing no operation.

8. The terminal device according to claim 6, wherein the step of determining whether two adjacent state change records are the same comprises:
when the previous state change record is the valid state, and the latter state change record is the valid state, or when the previous state change record is the invalid state, and the latter state change record is the invalid state, determining that the two adjacent change records are the same;
when the previous state change record is the valid state, and the latter state change record is the invalid state, or when the previous state change record is the invalid state, and the latter state change record is the valid state, determining that the two adjacent change records are different.

9. The terminal device according to claim 8, wherein the step of subtracting the time point of the previous state from the time point of the latter state change record when the two adjacent state change records are different, to obtain a time interval comprises:
when the two adjacent state change records are different and the valid state is changed to the invalid state, subtracting the time point of the previous state from the time point of the latter state change record to obtain a time interval.

10. The terminal device according to claim 9, wherein the step of determining the duration of a valid state based on the time interval comprises:
determining the end date and start date of the valid state;
counting time intervals corresponding to the change of all state change records from the valid state to the invalid state, and accumulating all the counted time intervals to obtain the invalid duration of the policy;
calculating the duration of the valid state of the policy based on the following formula:
(end date−start date)−invalid duration of the policy=the duration of the valid state of the policy.

11. A computer readable storage medium, having stored thereon a computer readable instruction, wherein when the computer readable instruction is executed by a processor, the following steps are implemented:
receiving a unique identifier of an insurance type of a policy;
searching for, in a log table, all state change records corresponding to the unique identifier of the insurance type of the policy;
sorting all the found state change records in chronological order;
determining whether two adjacent state change records are the same;
when the two adjacent state change records are different, subtracting the time point of the previous state from the time point of the latter state change record to obtain a time interval; and
determining the duration of a valid state based on the time interval.

12. The computer readable storage medium according to claim 11, wherein when the two adjacent state change records are the same, no operation is performed.

13. The computer readable storage medium according to claim 11, wherein the step of determining whether two adjacent state change records are the same comprises:
when the previous state change record is the valid state, and the latter state change record is the valid state, or when the previous state change record is the invalid state, and the latter state change record is the invalid state, determining that the two adjacent change records are the same;
when the previous state change record is the valid state, and the latter state change record is the invalid state, or when the previous state change record is the invalid state, and the latter state change record is the valid state, determining that the two adjacent change records are different.

14. The computer readable storage medium according to claim 13, wherein the step of subtracting the time point of the previous state from the time point of the latter state change record when the two adjacent state change records are different, to obtain a time interval comprises:
when the two adjacent state change records are different and the valid state is changed to the invalid state, subtracting the time point of the previous state from the time point of the latter state change record to obtain a time interval.

15. The computer readable storage medium according to claim 14, wherein the step of determining the duration of a valid state based on the time interval comprises:
determining the end date and start date of the valid state;
counting time intervals corresponding to the change of all state change records from the valid state to the invalid state, and accumulating all the counted time intervals to obtain the ivalid duration of the policy;
calculating the duration of the valid state of the policy based on the following formula:
(end date−start date)−invalid duration of the policy=the duration of the valid state of the policy.

16-20. (canceled)
